(19) United States
(12) Patent Application Publication
(10) Pub. No.: US 2016/0140096 A1
(43) Pub. Date: May 19, 2016

(54) EXCERPT SELECTION FEATURE FOR AN E-READING DEVICE

(71) Applicant: Kobo Inc., Toronto (CA)

(72) Inventors: Vanessa Ghosh, Toronto (CA); Benjamin Landau, Toronto (CA)

(21) Appl. No.: 14/543,703

(22) Filed: Nov. 17, 2014

(51) Int. Cl. G06F 17/24; G06F 3/0484

(52) U.S. Cl. CPC G06F 17/241; G06F 3/04842

(57) ABSTRACT

An e-reading device is provided that enables user-selected excerpts from one or more e-books to be aggregated as part of a separate content item. The e-reading device can also operate to programmatically generate bibliographic statements for each of the selected excerpts, based on attribution metadata from the e-book that is the source of each excerpt.

### TECHNICAL FIELD

Examples described herein relate to an excerpt selection feature for an e-reading device.

### BACKGROUND

An electronic personal display is a mobile electronic device that displays information to a user. While an electronic personal display is generally capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, and the like).

An electronic reader, also known as an e-reader device, is an electronic personal display that is used for reading electronic books (eBooks), electronic magazines, and other digital content. For example, digital content of an e-book is displayed as alphanumeric characters and/or graphic images on a display of an e-reader such that a user may read the digital content much in the same way as reading the analog content of a printed page in a paper-based book. An e-reader device provides a convenient format to store, transport, and view a large collection of digital content that would otherwise potentially take up a large volume of space in traditional paper format.

In some instances, e-reader devices are purpose-built devices designed to perform especially well at displaying readable content. For example, a purpose built e-reader device includes a display that reduces glare, performs well in highly lit conditions, and/or mimics the look of text on actual paper. While such purpose built e-reader devices excel at displaying content for a user to read, they can also perform other functions, such as displaying images, emitting audio, recording audio, and web surfing, among others.

There also exist numerous kinds of consumer devices that can receive services and resources from a network service. Such devices can operate applications or provide other functionality that links the device to a particular account of a specific service. For example, e-reader devices typically link to an online bookstore, and media playback devices often include applications which enable the user to access an online media library. In this context, the user accounts can enable the user to receive the full benefit and functionality of the device.

### BRIEF DESCRIPTION OF THE DRAWINGS

FIG. 1 illustrates a system that utilizes an e-reading device that includes an excerpt selection feature, according to an embodiment.

FIG. 2 illustrates an example of an e-reading device for use with one or more embodiments described herein.

FIG. 3 illustrates an e-reading system that is capable of providing an excerpt selection feature, according to one or more embodiments.

FIG. 4 illustrates an example method for implementing an excerpt selection feature on an e-reading device, according to an embodiment.

FIG. 5A and FIG. 5B illustrate examples for an excerpt selection feature in accordance with one or more embodiments.

FIG. 6 illustrates an example excerpt interface that is created in connection with operation of an excerpt interface feature, in accordance with one or more embodiments.

### DETAILED DESCRIPTION

Examples described herein include an e-reading device and a method of operation thereof, for providing an excerpt selection feature for selecting excerpts from an e-book. In the examples described below, an excerpt selection feature allows users to select statements, phrases or other portions (sometimes referred to as “quotations”) from individual e-books, and further to aggregate the selected excerpts as part of a separate content item or resource. Based on implementation, the content item can display multiple user-selected excerpts, either from one or multiple e-books.

In some variations, a user can view excerpts from an aggregated list of previously selected excerpts. The user can also act upon selected excerpts, including publishing or exporting excerpts to electronic documents, messages and/or social networking mediums. For example, a set of saved excerpts(s) from one or multiple sources can be exported to either a new document (e.g. Word document), to an existing document, or to an email. In some variations, a user can also publish selected excerpts to other mediums, such as to a social network site.

According to some embodiments, an e-reading device can generate and maintain a corresponding set of bibliographic information for each selected excerpt. The set of bibliographic information can display attribution for a corresponding excerpt that is selected from an e-book. The bibliographic information can be programmatically generated and stored in association with the excerpt.

Still further, in some variations, a user can have the option to select a reference or citation style for the manner in which the bibliographic information and/or excerpt is rendered. By way of example, a user can select a style from a set that includes APA style, MLA style, Chicago style, McGill Guide. Both the excerpt and the corresponding bibliographic statements can be automatically formatted for publication or display based on a user's selection of the reference or citation style.

In an embodiment, an e-reading device renders a segment of an e-book (including text and graphics) on a display. The e-book can include attribution metadata, such as author and date of publication. The user can make a selection of a portion of the e-book. In response to a user selection, a corresponding bibliographic statement is programmatically generated from the associated metadata of the e-book. The bibliographic statement can provide attribution for the selected excerpt.

In some aspects, a user can select to use an excerpt selection feature while viewing an e-book. An e-reading device can provide the excerpt selection feature as part of a toolbar with options for manipulating a style or format of the excerpt and/or its bibliographic information (which can be programmatically generated). In one example, a menu of citation styles is presented to the user for enabling user selection of a style for the bibliographic statement(s).

According to some variations, the e-reading device can programmatically generate bibliographic information for a selected excerpt in accordance with a preferred citation style. The preferred citation style can be based on user input, or alternatively based on a default setting or pre-selection by the user.

In another embodiment, an e-reading device is provided that enables user-selected excerpts from one or more e-books to be aggregated as part of a separate content item. The e-reading device can also operate to programmatically generate bibliographic statements for each of the selected excerpts, based on attribution metadata from the e-book that is the source of each excerpt.

In some variations, the user can select a reference or citation style for each of the generated bibliographic statements. The excerpts, and their respective bibliographic statements can be displayed as part of a separate document or content item in the selected reference or citation style.

In some embodiments, a collection of selected excerpts can be aggregated and stored as a content item on the e-reading device. The content item with the collection of excerpts, as well as corresponding bibliographic statements, can be stored on, for example, the e-reading device, or with a network service in connection with the user's account.

In variations, a selected excerpt can be published to a selected network resource, such as to the user's associated social networking account. Optionally, the selected excerpt can be published in accordance with a reference or citation style that is selected by the user.

In further aspects, the user can change the citation style of one or all of the excerpts provided in a collection of excerpts. A user can also export the collection of excerpts, or individual excerpts thereof, along with programmatically generated bibliographic statements, to a new document, existing document or other content item that is separately accessible from either the e-reading device or network service. In another further aspect, the user can publish one or more excerpts from the collection to a social networking account of the user.

An “e-reading device” can refer to any computing device that can display or otherwise render an e-book. By way of example, an e-reading device can include a mobile computing device on which an e-reading application can be executed to render content that includes e-books (e.g., comic books, magazines etc.). Such mobile computing devices can include, for example, a mufti-functional computing device for cellular telephony/messaging (e.g., feature phone or smart phone), a tablet device, an ultramobile computing device, or a wearable computing device with a form factor of a wearable accessory device (e.g., smart watch or bracelet, glass ware integrated with computing device, etc.). As another example, an e-reading device can include an e-reader device, such as a purpose-built device that is optimized for e-reading experience (e.g., with E-ink displays etc.).

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System Description

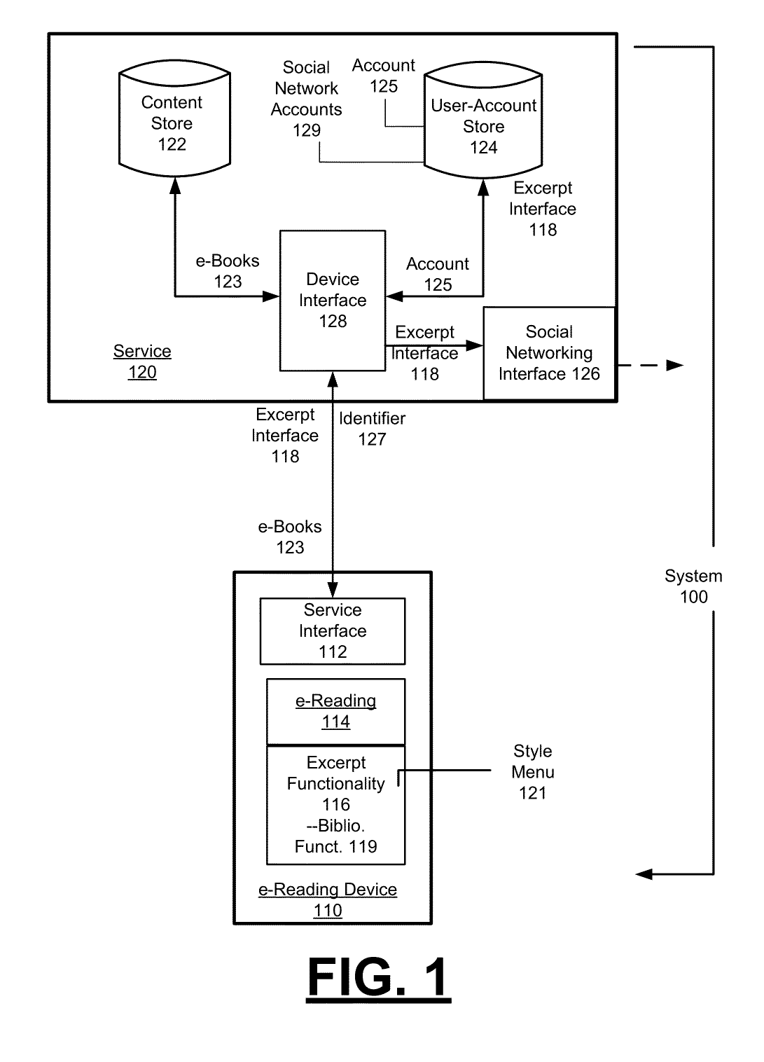

FIG. 1 illustrates a system that utilizes an e-reading device that includes an excerpt selection feature, according to an embodiment. The network service 120 may include multiple servers and other computing resources that provide various services in connection with one or more applications that are installed on the e-reading device 110. By way of example, in one implementation, the network service 120 can provide e-book services which communicate with corresponding e-reading functionality provided on the e-reading device 110. The e-book services can enable e-books 123 (including electronic magazines and other periodicals) to be downloaded or archived from e-reading device 110. The network service 120 can also provide other forms of content for download or streaming, such as videos or music. In this way, the network service 120 can provide various other content services, including content rendering services (e.g., streaming media) or other network-application environments or services.

The e-reading device 110 can correspond to any electronic personal display device having a touch-sensitive display assembly, and further on which applications and application resources (e.g., e-books, media files, and documents) can be rendered and consumed. For example, the e-reading device 110 can correspond to a tablet or a telephony/messaging device (e.g., smart phone). In one implementation, for example, e-reading device 110 can correspond to a mobile computing device (e.g., tablet) that runs an e-reading application to link the device to the network service 120 in order to enable e-books provided through the service to be viewed and consumed. Still further, by way of example, the e-reading device 110 can be equipped with hardware and software to optimize certain application activities, such as rendering of electronic content (e.g., e-books, including electronic magazines and other periodicals). For example, the e-reading device 110 can have a tablet like form factor, although variations are possible. In some cases, the e-reading device 110 can also have an E-ink display with touch or contact sensors.

In additional detail, the network service 120 can include a device interface 128, a content store 122 and a user account store 124. The user account store 124 can associate the e-reading device 110 with a user and with an account 125. The account 125 can also be associated with one or more application resources (e.g., content item such as an e-books), which can be stored in the resource store 122. As described further, the user account store 124 can retain metadata for individual accounts 125 to identify resources that have been purchased or made available for consumption for a given account.

In some variations, the network service 120 can also provide a social network service, and/or provide programmatic access and use of a third-party social network service. Accordingly, the network service 120 can include a social network interface 126, and the user account store 124 can also retain information that link to one or more social networking accounts 129 of an individual user.

The e-reading device 110 may be associated with the user account 125, and multiple devices may be associated with the same account. As described in greater detail below, the e-reading device 110 can store resources (e.g., e-books) that are purchased or otherwise made available to the user of the e-reading device 110, as well as to archive e-books and other digital content items that have been purchased for the user account 125, but are not stored on the particular computing device.

The e-reading device 110 can include a service interface 112 and an e-reading component 114. The e-reading device 110 can execute the service interface 112 to receive and send resources and data to and from the network service 120. The service interface 112 can signal, to the network service 120, an identifier for the user and/or user account. The service interface 112 can interface with the network service 120 to receive resources such as applications and content items (e.g., e-books, music files, etc.) from the network service, as well as to perform other activity, such as activity to link resources and content to the user account. Optionally, the e-reading device 110 can communicate with multiple services in order to receive resources. The resources can be received in response to user-input or action (e.g., purchasing input), or automated (e.g., automatic download of new issue of periodical based on user subscription of electronic periodical).

The e-reading device 110 can execute the e-reading component 114 to enable e-reading activities. In one aspect, the e-reading component 114 can render paginated content from e-books (e.g., electronically formatted literary works). Many e-books, such as literary works which are primarily text-based (e.g., novels) can be paginated on-the-fly by the e-reading component 114, based on, for example, a display size of the device and/or font size settings of the user or device.

The e-reading device 110 operates to provide an excerpt selection feature 116 for enabling the user to select excerpts from rendered e-books, and further to enable the user to aggregate excerpts from one or more e-books. The excerpt selection feature 116 includes functionality that detects when a user makes a selection of a portion of an e-book. In one implementation, the excerpt selection feature 116 is provided as integrated functionality with the e-reading component 114. The excerpt selection feature 116 can, for example, be provided as supplemental functionality of the e-reading component 114. By way of example, the e-reading component 114 can provide a toolbar or other menu set with input features for enabling the user to activate and select text using the excerpt selection feature 116.

In some embodiments, when the excerpt selection feature 116 is operated to select an excerpt, bibliographic functionality 119 provided with the excerpt selection feature 116 automatically generates a bibliographic statement that provides attribution for the excerpt. The bibliographic statement can be generated from metadata associated with the e-book. Additionally, the bibliographic statement can be stored, displayed or otherwise associated with the corresponding excerpt.

The excerpt selection feature 116 can include one or more selection features, including a selection feature for enabling the user to select formatting for bibliographic statements that provide attribution for the excerpt. In one implementation, the excerpt selection feature 116 includes a style menu 121, from which the user can make selection of a citation or reference style of a bibliographic statement generated by the bibliographic functionality 119 for a selected excerpt. With selection of a particular style from the style menu 121, an identified bibliographic statement or set of statements can be formatted in accordance with the particular citation style.

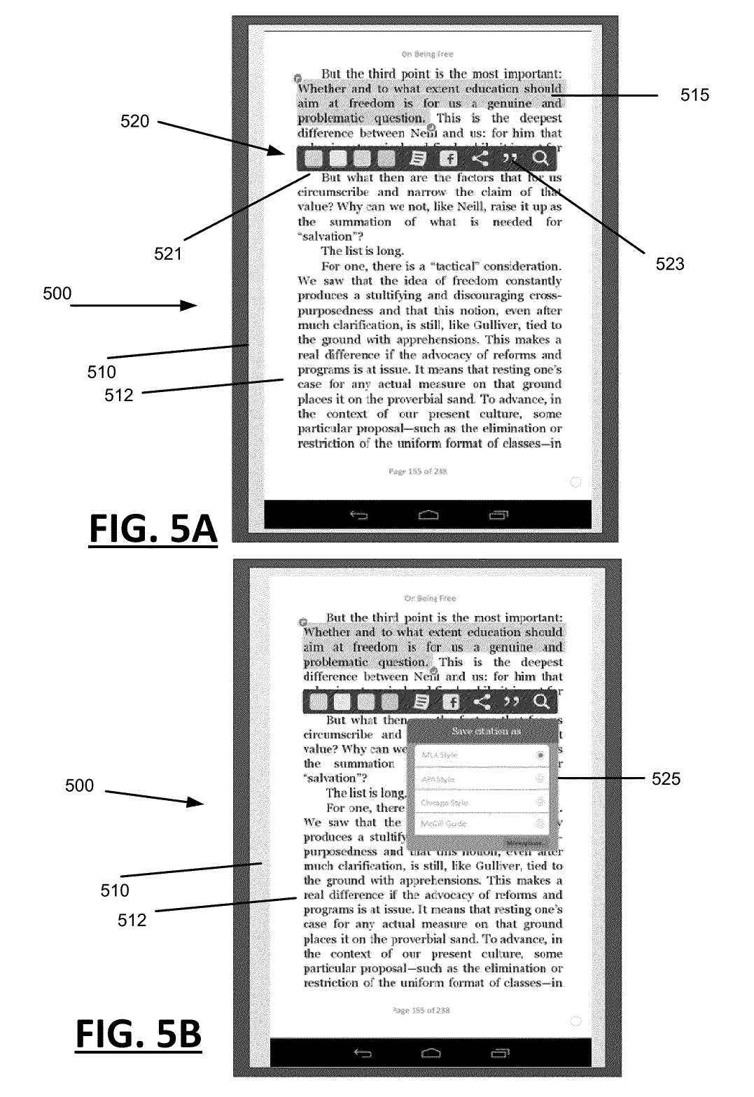

According to some implementations, the selected excerpt and bibliographic statement can be displayed on an excerpt interface 118. FIG. 5A and FIG. 5B show an example of an excerpt interface 118 for enabling selection of excerpts, along with generation and formatting of bibliographic statements that accompany the excerpts. Some or all of the bibliographic statements provided on an excerpt interface 118 can be formatted in accordance with a selected citation style. Based on user selection and implementation, multiple citation styles can alternatively be used for different excerpts provided on excerpt interface 118.

The excerpt interface 118 can correspond to a page that is renderable with e-reader component 114. As an addition or alternative, the excerpt interface 118 can correspond to a content item, or collection of content items, that is renderable with alternative programming platforms, such as a document viewer, messaging program, or browser. The excerpt interface 118 can be stored in local memory of the e-reading device 110 and/or on the network service 120. In one implementation, the excerpt interface 118 can be sent to the network service 120 to be retained in the user account store 124. Additionally, the excerpt interface 118 can be published as a content item on the user's social networking account 129 through the social networking interface 126.

Hardware Description

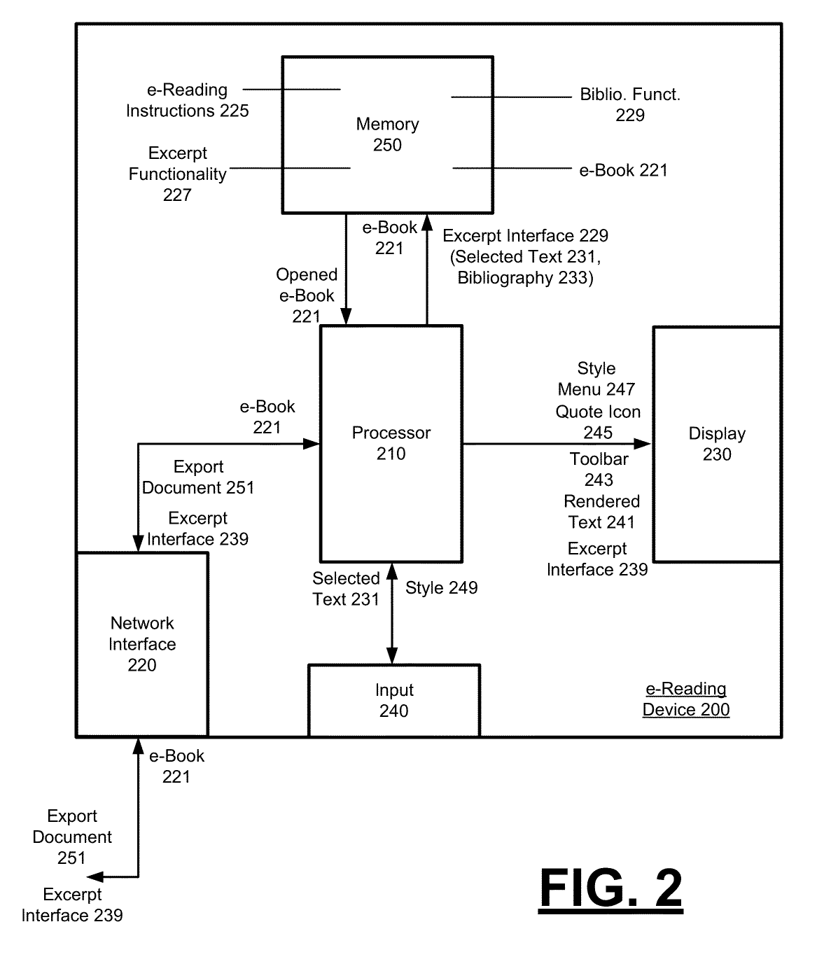

FIG. 2 illustrates an example of an e-reading device for use with one or more embodiments described herein. In an example of FIG. 2, an e-reading device 200 can correspond to, for example, a mobile computing device such as shown by an example of FIG. 1.

With reference to FIG. 2, e-reading device 200 includes a processor 210, a network interface 220, a display 230, one or more input mechanisms 240, and a memory 250. The processor 210 can implement functionality using instructions stored in the memory 250. Additionally, in some implementations, the processor 210 utilizes the network interface 220 to communicate with the network service 120 (see FIG. 1). More specifically, the e-reading device 200 can access the network service 120 to receive various kinds of resources (e.g., digital content items such as e-books, configuration files, account information), as well as to provide information (e.g., user account information, service requests etc.). For example, e-reading device 200 can receive application resources, such as media files (e.g., e-books 221) that the user elects to purchase or otherwise download from the network service 120. The application resources that are downloaded onto the e-reading device 200 can be stored in the memory 250.

In some implementations, the display 230 can correspond to, for example, a liquid crystal display (LCD) or light emitting diode (LED) display that illuminates in order to provide content generated from processor 210. In some variations, the display 230 can correspond to an electronic paper type display, which mimics conventional paper in the manner in which they display content. Examples of such display technologies include electrophoretic displays, electrowetting displays, and electrofluidic displays.

In some implementations, the display 230 can be touch-sensitive. For example, the display 230 can be integrated with a sensor layer that is comprised of capacitive touch sensors which trigger with contact to human skin. Alternatively, the display 230 can include alternative sensor layers, such as resistive sensors which can detect applied pressure from, for example, a human finger or stylus.

The processor 210 can receive input from various sources, including from input mechanisms 240 (e.g., buttons or switches, microphone, keyboard), the display 230 (e.g., soft buttons or virtual keyboard) or other input mechanisms (accessory devices). In one implementation, the processor 210 can process multi-touch input detected by the sensor layer provided on the display 230.

In one aspect, memory 250 stores instructions 225 (“e-reading instructions 225”) for operating an e-reading application (e.g., see e-reader component 114 in FIG. 1). Additionally, the memory 250 stores instructions 227 for providing excerpt selection feature 116 (FIG. 1) (“excerpt selection instructions 227”) and instructions 229 for providing bibliographic functionality 119 (“bibliographic instructions 229”).

The processor 210 can execute e-reading instructions 225 when the user views an e-book (e.g., renders pages from an e-book). Additionally, the processor 210 executes excerpt selection instructions 227 in order to detect user input from rendered pages of an e-book. The processor 210 executes excerpt selection instructions 227 to select text portions 231 from rendered text 241 of an opened e-book 221.

The processor 210 can also execute bibliographic instructions 229 when providing the e-reading component 114. In one implementation, the processor 210 executes e-reading instructions 225, excerpt selection instructions 227 and bibliographic instructions 229 to provide a toolbar 243 with an excerpt selection feature 245. The excerpt selection feature 245 enables the user to provide input from which excerpt selection can be identified and recorded. If the user selects excerpt selection feature 245 from the toolbar 243, the processor 210 can execute the bibliographic instructions to provide a style menu 247 below or with the toolbar 243. Based on the user's selection of style 249 from the style menu 247, the processor executes excerpt selection instructions 227 and bibliographic instructions 229 to compile the excerpt interface 239. The excerpt interface 239 can provide a collection of selected text 231, representing excerpts from e-books viewed by the user. The excerpt interface 239 can be provided with a corresponding bibliographic statement 233 in the selected style 249. The selected texts 231 in the collection of the excerpt interface 239 can be compiled from the same e-book or from different e-books.

In one implementation, the excerpt interface 239 is saved in local memory 250 of the e-reading device 200. Additionally, as the user operates the e-reading device, the user can add to the excerpt interface 239 by identifying other selected text portions 231 (either from the opened e-book 221 or from another e-book).

In another aspect, the excerpt interface 239 can also be displayed on the e-reading device. The bibliographic instructions 229 can also be executed to enable the user to change the citation style of the bibliographic statements of the selected text portions. The user can either change the style to be uniform for all the selected text portions on excerpt interface 239, or choose to change the style of just one or more text portions on excerpt interface 239.

In another aspect, the user can select to export the excerpt interface 239, or portion thereof (e.g., a user selection of one or more excerpts provided with the excerpt interface 239). The excerpt interface 239 can, for example, be exported to an export document 251 (for e.g. Word document) that is accessible separately from the e-reading device. The export document 251 can be a new document, an existing document stored on the e-reading device 200, a message or other form of content item. The processor 210 can send the document 251 through the network interface 220 to a desired location.

In another variation, the export document 251 can be a content item on the user's social networking account associated with the user's e-reading service account. In yet another variation, the e-reading device can store the excerpt interface 239 on the user's account store on the network service 120 (see FIG. 1).

Device System

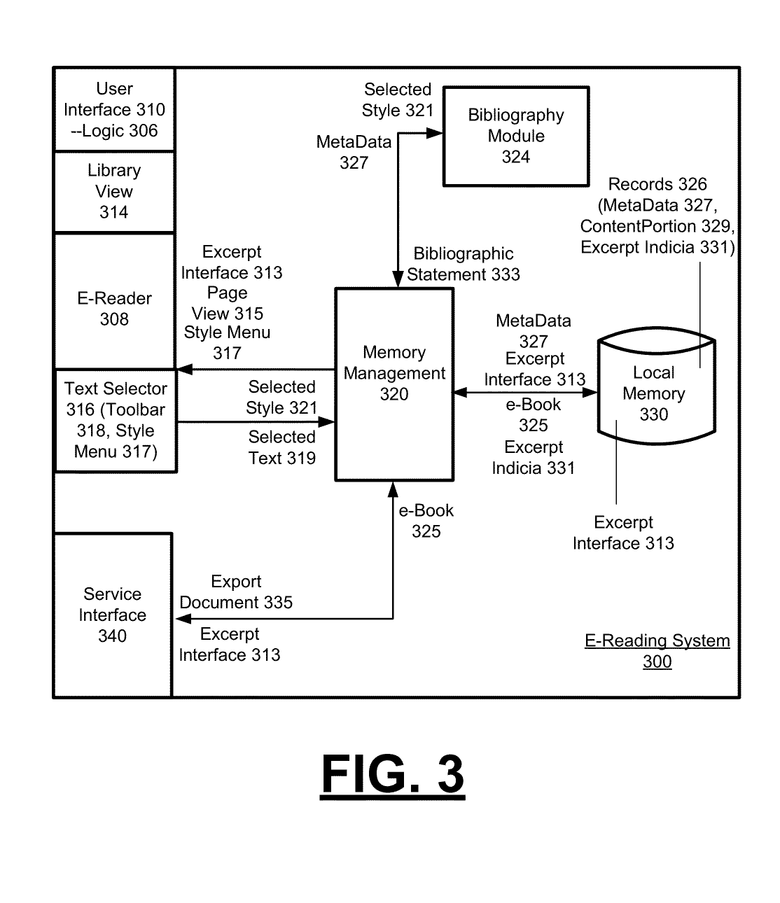

FIG. 3 illustrates an e-reading system that is capable of providing an excerpt selection feature, according to one or more embodiments. In particular, a system 300 can provide a way for the user to select and copy text portions from e-books and compile an excerpt interface that stores the selected text portions. The system 300 can further generate a bibliographic statement for the selected text portion and include it along with the text portion on an excerpt interface. The system of 300 can further include an e-reading device that provides for a touch-sensitive display assembly, such as described with an example of FIG. 2.

In more detail, system 300 implements programmatic components for communicating with one or more network service (such as network service 120, shown in FIG. 1), as well as for enabling functionality for viewing and accessing content items (e.g., e-books) utilized by an account associated with the e-reading device 110 (see FIG. 1). In some embodiments, the system 300 can be implemented as an application that runs on an e-reading device, such as shown with examples of FIG. 1 or FIG. 2. In variations, the system 300 can be implemented as part of the operating system for the e-reading device.

In an example of FIG. 3, system 300 includes a user interface 310, a memory management module 320, a bibliography module 324, a local memory 330, and a service interface 340. Some or all of the programmatic components shown with the computing system 300 can be provided in part as operating system-level components. Alternatively, the programmatic components shown with the computing system 300 can be provided as part of an application or application platform that runs on, for example, the e-reading device 110 (see FIG. 1). For example, the user can download an application onto the device that is operated as the e-reading device 110, in order to obtain functionality such as described with an example of FIG. 3, as well as to communicate with the network service 120. Alternatively, an application can be embedded or otherwise preinstalled with other programmatic elements for providing functionality such as described with system 300.

The service interface 340 includes application logic which enables the e-reading device 110 to use, for example, a wireless Internet connection, to connect to the network service 120 (see FIG. 1). In connecting with the service, the service interface 340 can transmit data that enables the network service 120 to identify the e-reading device 110 on which system 300 is implemented, so that the network service 120 can determine the account that is associated with the particular e-reading device. The service interface 340 can be used to retrieve e-books 325 from the network service 120. For example, in identifying the e-reading device 110 of system 300 to the network service 120, the network service may be able to procure payment information (e.g., stored credit card information) that can be used to charge the user's account when the user purchases a new e-book from the service. Each e-book can correspond to a literary work having a pagination format, such as provided by literary works (e.g., novels). Other e-books can have pagination which is statically predetermined, such as in the case of some periodicals (e.g., magazines, comic books, journals, etc.). Optionally, some e-books may have chapter designations, as well as content that corresponds to graphics or images (e.g., such as in the case of magazines or comic books). Individual e-books 325 also include metadata 327, such as imagery provided as a cover for the e-book when the e-book is marketed (e.g. similar to the manner in which a conventional hardbound book would be marketed in a retail store). Metadata 327 can also include the bibliographic details of the e-book including the title of the e-book, the author and the date of publication. In one implementation, the network service 120 can retrieve or otherwise identify the imagery and other metadata 327 of individual e-books from publisher sources.

In identifying the e-reading device of system 300, the network service 120 can identify what e-books belong to the account associated with the particular device. The e-books that are transmitted to the e-reading device of system 300 can include, for example, those e-books that are purchased from the device, or those e-books that the user requested to download. In variations, e-books can be automatically downloaded to the device in response to occurrence of certain conditions. For example, the user can purchase an e-book on another device, and then subsequently connect to the network service 120 via the e-reading device 110 to automatically receive their previously purchased e-book. As another example, network service 120 can be configured to push e-books to the e-reading device 110 of system 300, based on, for example, user account settings, subscription plans and rules, and various other business logic considerations.

Additionally, the service interface 340 can include processes for automatically receiving updates from a network service 120. The update can include programmatic updates, including updates to software components on the e-reading device 110, as well as updates to lists, download of e-books that the user may have purchased on another device of the same account, recommendations from the network as to what a given user may want to purchase or view, and/or various other data that can be either generally provided to the user of the network service or specifically provided for to the particular account or user.

According to some embodiments, the local memory 330 stores each e-book as a record 326 that includes metadata 327 and content 329 (e.g., page content). The memory management module 320 can include distributed memory resources, such as cache resources utilized by the e-reading component 308. The memory management module 320 can retrieve portions of the content 329 for individual e-books for purpose of rendering e-books via the user interface 310. Additionally, the memory management module 320 can retrieve metadata 327 to render metadata content (e.g., representations of e-books or lists of e-books) with the user interface 310.

In an example of FIG. 3, the user interface 310 includes user interface logic 306, a library view component 314 and an e-reading component 308. The user interface logic provides rules, parameters and other logic to interpret input for the different modes that can be implemented on the device of system 300.

The library view 314 can display objects and metadata that represent individual e-books and content items of the user library. In one implementation, the library view 314 can display metadata content based on the metadata portion 327 of individual e-books that are in the user library. The e-books that are in the user library can correspond to e-books stored with local memory 330, as well as archived e-books that are provided remotely (e.g., provided on network service 120).

Among other functionality, the e-reading component 308 renders e-books and other text content. The e-reading component 308 can include functionality to (i) render page views 315 from a particular e-book, and (ii) detect and copy selected text 319 (corresponding to the selected excerpt). The page views 315 can include the content portion 329 of the e-book being read (e.g., opened or rendered). For example, the e-reading component 308 can display a page view 315 from an e-book corresponding to a novel or periodical, and the page view may include text and/or image content.

The selected text 319 can be identified by, for example, the user touching a portion of the text and highlighting it with the cursors like on a smartphone. The selection of text can be implemented by an excerpt selection feature 316 which includes processes for (i) detecting the user providing input to highlight a portion of the rendered text, and (ii) copying the selected text for use with an excerpt interface 313. Once a portion of the text is selected, the excerpt selection feature 316 displays a toolbar 318 which includes one or more icons associated with functionality to manipulate the selected text. When the user selects the icon on the toolbar associated with the quotation exporter, the excerpt selection feature 316 provides a style menu 317. The style menu provides choices to the user for selection of citation styles for the selected text 319.

Once the user selects a style 321, the memory management module 320 extracts the metadata 327 associated with the e-book that contains the selected text 319. Metadata 327 as described above is stored as a part of the record 326 associated with a particular e-book 325 in the local memory 330. The memory management module 320 then passes the selected style 321 and the extracted metadata 327 to the bibliography module 324.

The bibliography module 324 programmatically generates a bibliographic statement 333 using the metadata 327 in the selected style 321. Some examples of different referencing or citation styles that can be programmed in the bibliography module include APA style, MLA style, Chicago style, McGill Guide. Based on the particular style, the bibliography module 324 generates the bibliographic statement 333 by formatting the metadata so that it conforms to the rules of the referencing style. The bibliography module 324 may also generate text, and/or modify the formatting of the excerpted text. Once the bibliographic statement 333 is generated, it passes it to the memory management module 320 for further processing. The bibliography module 324 is also invoked when the user selects to change the citation style of a selected text portion on the excerpt interface 313, once it is compiled as described below.

The memory management module 320 combines the bibliographic statement 333 with the selected text 319 and stores the combination as part of excerpt interface 313. The excerpt interface 313 can have various forms, such as in the form of a page (e.g., quotation page), document or other content item. Excerpt interface 313 can be stored in the local memory 330 or can be sent to be stored on the user's account store on the e-reading service 120 (see FIG. 1) through the service interface 340. In one implementation, the excerpt interface 313 can also be displayed on the e-reading device through the e-reading component 308. For example, the excerpt interface 313 can be rendered as an additional page of an e-book, or it can be filed and stored as a separate document from other e-books. The user can also select the style of the selected text portions within the excerpt interface 313.

One or more of the text portions 319 with their bibliographic statements from the excerpt interface 313 can also be exported into an export document 335. Once the user interface 310 triggers the memory management module 320 for export, the selected text portions 319 are copied to the export document 335 along with the corresponding bibliographic statements 333. The memory module 320 can create a new document, copy onto an existing document or create an email message with the export document 335. Once the export document 335 is finalized, it can be transmitted to an external store through the service interface 340.

As an addition or variation, the selected text 319 can be published to an online source. For example, the user can select one or more excerpts from a favorite e-book for publication on a social network service of the user.

Methodology

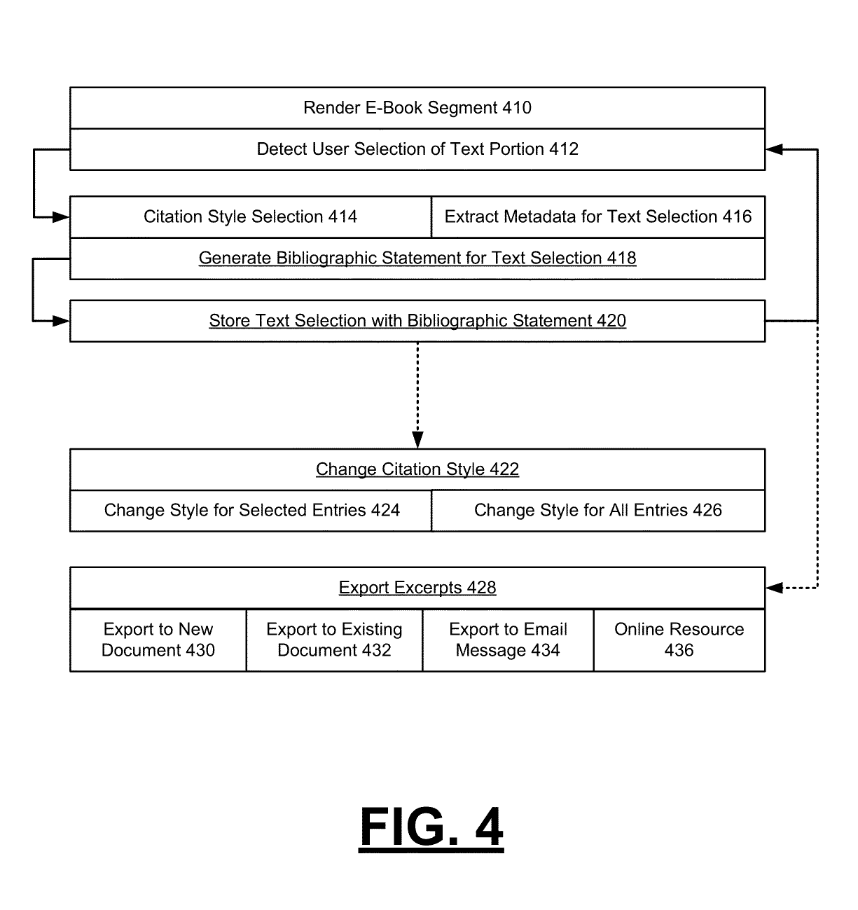

FIG. 4 illustrates an example method for implementing an excerpt selection feature on an e-reading device, according to an embodiment. In describing an example method of FIG. 4, reference may be made to elements of a system of FIG. 1, an e-reading device of FIG. 2, or an e-reading system of FIG. 3, for purpose of illustrating suitable components for performing a step or sub-step being described. For example, stored instructions corresponding to one or more aspects of the method of FIG. 4 may be executed by one or more processors, operating hardware of an e-reading device.

With reference to FIG. 4, e-reading device 110 renders a segment of the e-book content (410). This can include paginated content, and various page transition mechanisms can be utilized to implement page transitions. For example, the user can tap an edge of a display screen of the device to perform a page turn or the user can touch the displayed text and select a portion of the text using the fingers. Once a portion of the text is selected, the processor can implement an excerpt selection feature by detecting the user making a selection of text from a rendered page or set of pages (412).

Once the user selects a citation style (414), and the metadata associated with the selected text portion is extracted (416), the processor 210 generates a bibliographic statement for the text selection in the selected style (418). The text selection and the bibliographic statement is then stored in a content item on the e-reading device (420). The bibliographic statement can be generated in accordance with a particular bibliographic style. A toolbar or other interactive feature can enable the user to trigger a style menu for selection of a citation style for a bibliographic statement associated with the selected text portion. The bibliographic statement can be generated based on the attribution metadata associated with the e-book that is being displayed on the e-reading device.

Steps 410 through 420 can be repeated for multiple text portions within the same e-book or multiple text portions from different e-books. Once the user chooses to display the content item with the collection of text portions, the user can perform additional functions.

Among the additional functions, the user can change the citation style of the bibliographic statement associated with the text portions (422). The user can change the style of the bibliographic statement of one or more text portions at a time (424). Alternatively, the user can change the style of the bibliographic statement of all the text portions to one uniform style (426).

Still further, the user can export one or more selected text portions to a rendering medium (428). The rendering medium can correspond to, for example, a new document (430), an existing document (432), an email message (434), or an online resource (436) (e.g., web page, such as social network or blog).

### Examples

FIG. 5A and FIG. 5B illustrate examples for an excerpt selection feature in accordance with one or more embodiments. In more detail, FIG. 5A illustrates an e-reading device 500 having a display 510 on which a page 512 of an e-book is rendered. An excerpt selection input feature 520 can be invoked by the user when viewing 512. The excerpt selection input feature 520 includes features 521 to enable the user to select text 515, by way of, for example, a highlight. When highlighted, text content can be highlighted. A quotation feature 523 enables text selection to generate an excerpt, which can be copied onto a document or other medium. As a variation or addition, excerpted text can be identified by way of highlight.

FIG. 5B shows an example of the style menu 525 that is displayed once the user selects quotation feature 523. As described with other examples, the selection of an excerpt can result in automatic generation of a bibliographic statement for the selected excerpt. The style menu 525 enables the user to select a particular style for how the excerpt is displayed, as well as a format of a bibliographic statement that is generated for the excerpt.

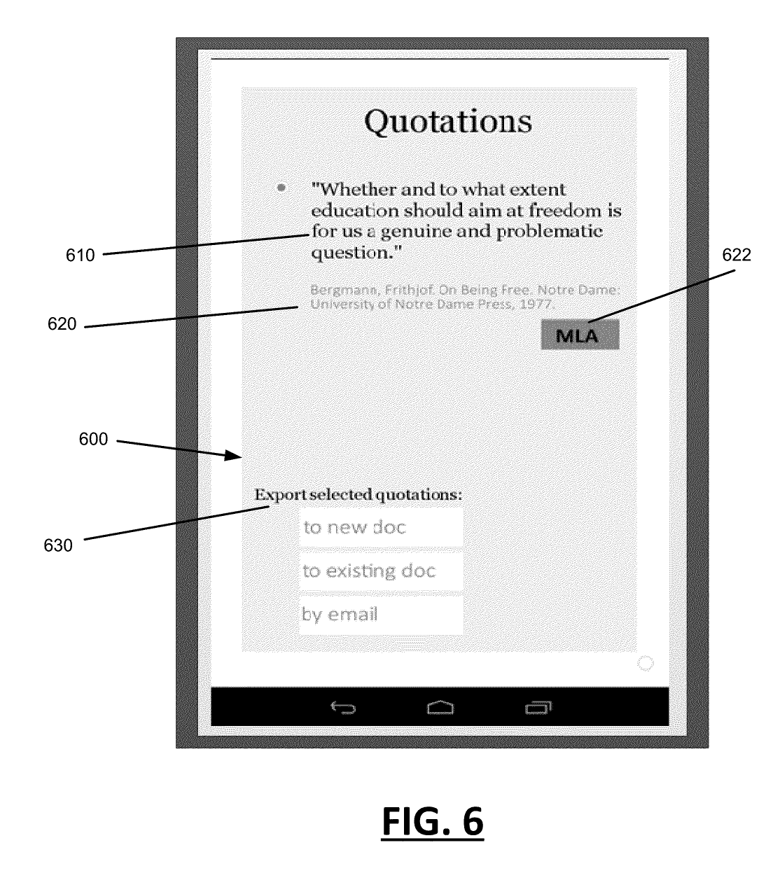

FIG. 6 illustrates an example excerpt interface that is created in connection with operation of an excerpt interface feature, in accordance with one or more embodiments. An example excerpt interface 600 shows an excerpted text portion 610, such as selected in FIG. 5A and FIG. 5B. The excerpted text portion 610 can be displayed with an associated bibliographic statement 620. The bibliographic statement 620 can be in a style such as selected with style menu 525 shown by an example of FIG. 5B. A feature 622 can be provided to identify the selected style, and the feature can be selectable to trigger a menu which allows the user to change the selected style.

The example excerpt interface 600 in FIG. 6 also shows features 630 for enabling the user to select to export the excerpt interface 600 to another resource. The export features 630 include features for selecting exporting to a new document, an existing document or by email.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for operating an e-reading device, the method being implemented by one or more processors and comprising:
(a) rendering a segment of an e-book, the e-book being associated with attribution metadata;
(b) while rendering the segment of the e-book, detecting a user selecting a text portion from the segment; and
(c) programmatically generating a bibliographic statement for attribution of the text portion based on the attribution metadata of the e-book.

2. The method of claim 1, further comprising selecting a citation style for the programmatically generated bibliographic statement.

3. The method of claim 2, wherein selecting a citation style for the programmatically generated bibliographic statement is based on either a user setting or a default setting.

4. The method of claim 2, wherein selecting a citation style for the programmatically generated bibliographic statement includes selecting a citation style from multiple available citation styles.

5. The method of claim 1, further comprising:
repeating (a) through (c) for multiple text portions of the e-book;
aggregating a collection of selected text portions; and
storing the collection of text portions as a content item on the e-reading device, each of the text portions in the collection including a corresponding programmatically generated bibliographic statement.

6. The method of claim 5, further comprising selecting a citation style for each of the programmatically generated bibliographic statements based on either a user setting or a default setting.

7. The method of claim 6, further comprising:
responsive to a user input, displaying the content item with the collection of text portions; and
changing the citation style of the programmatically generated bibliographic statement associated with each of the text portions in the collection based on a user designation.

8. The method of claim 6, further comprising:
responsive to a user input, displaying the content item with the collection of text portions; and
changing the citation style of the programmatically generated bibliographic statements associated with all of the text portions in the collection based on a user designation.

9. The method of claim 6, further comprising:
responsive to a user input, displaying the content item with the collection of text portions; and
responsive to a user designation, copying one of more text portions in the collection including the corresponding programmatically generated bibliographical statement to an electronic document that is separately accessible from the e-book.

10. The method of claim 6, further comprising:
responsive to a user input, displaying the content item with the collection of text portions; and
responsive to a user designation, copying one of more text portions in the collection including the corresponding programmatically generated bibliographical statement to an email message.

11. The method of claim 9, wherein the electronic document that is separately accessible from the e-book is either a new document or an existing document.

12. The method of claim 1, further comprising:
repeating (a) through (c) for multiple text portions of different e-books;
aggregating a collection of selected text portions; and
storing the collection of text portions as a content item on the e-reading device, each of the text portions in the collection including a corresponding programmatically generated bibliographic statement.

13. The method of claim 12, further comprising selecting a citation style for each of the programmatically generated bibliographic statements based on either a user setting or a default setting.

14. The method of claim 13, further comprising:
responsive to a user input, displaying the content item with the collection of text portions; and
changing the citation style of the programmatically generated bibliographic statement associated with each of the text portions in the collection based on a user designation.

15. The method of claim 13, further comprising:
responsive to a user input, displaying the content item with the collection of text portions; and
changing the citation style of the programmatically generated bibliographic statements associated with all of the text portions in the collection based on a user designation.

16. The method of claim 13, further comprising:
responsive to a user input, displaying the content item with the collection of text portions; and
responsive to a user designation, copying one of more text portions in the collection including the corresponding programmatically generated bibliographical statement to an electronic document that is separately accessible from the e-book.

17. The method of claim 13, further comprising:
responsive to a user input, displaying the content item storing the collection of text portions; and
responsive to a user designation, copying one of more text portions in the collection including the corresponding programmatically generated bibliographical statement to an email message.

18. The method of claim 1, further comprising publishing the text portion and the programmatically generated bibliographic statement as a content item on a social network account of the user.

19. A computing device, comprising:
a memory resource to store a set of instructions and an e-book; and
one or more processors that access the memory resource to:
render a segment of an e-book, the e-book being associated with attribution metadata;
while rendering the segment of the e-book, detect a user selecting a text portion from the segment;
programmatically generate a bibliographic statement for attribution of the text portion based on the attribution metadata of the e-book;
select a citation style for the programmatically generated bibliographic statement based on either a user setting or a default setting;
aggregate a collection of selected text portions;
store the collection of text portions as a content item on the e-reading device, each of the text portions in the collection including a corresponding programmatically generated bibliographic statement in the citation style selected;
responsive to a user input, displaying the content item with the collection of text portions;
changing the citation style of the programmatically generated bibliographic statement associated with each of the text portions in the collection based on a first user designation; and
responsive to a second user designation, copying one of more text portions in the collection including the corresponding programmatically generated bibliographical statement to either an email message or an electronic document that is separately accessible from the e-book.

20. A computer-readable medium for operating an e-reading device, the computer-readable medium storing instructions that, when executed by one or more processors, cause the e-reading device to perform operations that include:
rendering a segment of an e-book, the e-book being associated with attribution metadata;
while rendering the segment of the e-book, detecting a user selecting a text portion from the segment;
programmatically generating a bibliographic statement for attribution of the text portion based on the attribution metadata of the e-book; and
selecting a citation style for the programmatically generated bibliographic statement based on either a user setting or a default setting.
